(19) United States
(12) Patent Application Publication
(10) Pub. No.: US 2024/0332710 A1
(43) Pub. Date: Oct. 3, 2024

(54) Backpack device

(71) Applicant: Hilti Aktiengesellschaft, Schaan (LI)

(72) Inventor: Andreas Janecke, Landsberg am Lech (DE)

(21) Appl. No.: 18/578,129

(22) PCT Filed: Jul. 18, 2022
(86) PCT No.: PCT/EP2022/070019

§ 371 Date: Jan. 10, 2024

(30) Foreign Application Priority Data
Jul. 20, 2021 (EP) 21186551.4

(51) Int. Cl. H01M 50/256; A45F 3/00; A45F 3/04; H01M 50/204; H01M 50/247; H01M 50/269

(52) U.S. Cl. CPC H01M 50/256; A45F 3/04; H01M 50/204; H01M 50/247; H01M 50/269; A45F 2003/003; H01M 2220/30

(57) ABSTRACT

A backpack device having a harness unit and a battery pack receptacle, fastened thereto, for receiving a battery pack, and having a connection device for connecting a hand-held electrical device, wherein the backpack device has a configuration interface via which energy to be output via the connection device is able to be configured in terms of current and/or voltage.

The present invention relates to a backpack device having a harness unit and a battery pack receptacle, fastened thereto, for receiving a battery pack, and having a connection device for connecting a hand-held electrical device. The battery pack is intended to supply a hand-held electrical device with energy.

### BACKGROUND

EP 3 605 784 A1 discloses a carrying device having a carrying frame and an energy store carried by the carrying frame. The carrying device also has a transformer device for transforming an electric current drawn from the energy store, and an electrical connection device for connecting a consumer. The transformer device converts direct current into alternating current.

U.S. Pat. No. 5,929,597 A describes a portable energy supply system having a battery pack and a wired adapter, which is electrically connected to the battery pack and is intended for connection to an electric hand-held power tool. The wired adapter has a voltage selector.

DE 20 2013 102 928 U1 discloses a backpack-type power supply, which comprises a rechargeable battery and an operator control unit equipped with a switch, wherein the switch is designed to activate or deactivate the rechargeable battery.

### SUMMARY OF THE INVENTION

It is an object of the present invention is to specify a backpack device which promotes increased versatility.

The present invention provides that the backpack device has a configuration interface by means of which energy to be output via the connection device is able to be configured in terms of current and/or voltage.

The invention incorporates the finding that backpack devices known from the prior art are typically intended for a particular electrical tool type and are scarcely modular. The configuration interface provided according to the invention creates the basis for a wide field of application of the backpack device. Thus, provision may be made for example for a voltage to be able to be configured both in terms of amplitude and in terms of frequency. It has been found to be advantageous when a frequency of 50 Hz and/or 60 Hz is able to be configured for the voltage. In a preferred configuration, a sine-wave voltage profile and/or a square-wave voltage profile may be defined for the voltage.

In a particularly preferred configuration, the battery pack receptacle is designed to simultaneously receive two battery packs. It has been found to be advantageous when the battery pack receptacle is designed to simultaneously receive two battery packs of the same type. In a further particularly preferred configuration, the backpack device has a switching device by means of which it is possible to switch between a serial connection and a parallel connection of the two battery packs. It is thus possible, in the case of a serial connection of the two battery packs, to achieve doubling of the voltage to be output via the connection device, without using a DC-DC converter. Of course, the switching device can also be operated at the same time with a DC-DC converter. It has been found to be advantageous when the switching device is connected to the configuration interface electrically and/or for signal transmission. In this way, it is possible for example to switch to a parallel connection of the two battery pack via the configuration interface.

In a further particularly preferred configuration, the backpack device has an inverter or a DC-DC converter. It has been found to be advantageous when the backpack device has both an inverter and a DC-DC converter. In this way, a particularly broad spectrum of voltages and/or currents can be provided by the backpack device. It has been found to be advantageous when the switching device is connected to the inverter and/or the DC-DC converter electrically and/or for signal transmission. In this way, it is possible for example for an output voltage and/or an output current of the inverter and/or of the DC-DC converter to be defined.

In a particularly preferred configuration, the configuration interface is wireless. The configuration interface may for example be designed to be able to operate one or more radio standards from the group: WLAN, NFC, Bluetooth. It has been found to be advantageous when the backpack device has a mobile operator control unit or the backpack device is assigned a mobile operator control unit. The operator control unit is advantageously designed to enter into a wireless connection with the configuration interface. The mobile operator control unit may be for example a smartphone or a smartwatch. It has been found to be advantageous when a computer program product in which the configuration interface is implemented is stored in a memory of the mobile operator control unit.

Alternatively or additionally, the configuration interface can be wired and/or the configuration interface can be arranged on the backpack device. It has been found to be advantageous when the configuration interface is in the form of or has a touchscreen or a switch panel. In a further particularly preferred configuration, the configuration interface has a flash EEPROM in which a parameter, which represents a desired output voltage and/or a desired output current of the rectifier and/or of the DC-DC converter, can be stored by a user.

In a further particularly preferred configuration, the connection device is modular. The connection device may have a universal base on which various sockets of different types can be fitted. Preferred types are IEC 60309 blue (200-250 V, 50/60 Hz), red (380-480 V, 50/60 Hz) and green (20-500 V, 60-500 Hz).

In a particularly preferred configuration, the backpack device has two shoulder straps, preferably exactly two shoulder straps. A first of the shoulder straps can be in the form of or be intended to be a left shoulder strap. A second of the shoulder straps can be in the form of or be intended to be a right shoulder strap. In a further particularly preferred configuration, the shoulder strap has a flexurally elastic shoulder bracket. Alternatively, the shoulder strap can be formed by a flexurally elastic shoulder bracket. It has been found to be advantageous when the backpack device and/or the harness unit remains free of the battery pack receptacle in its top third, in relation to the total length of the backpack device.

In a particularly preferred configuration, the battery pack receptacle has a receiving bay. It has been found to be advantageous when the battery pack receptacle has a cover flap for closing the receiving bay. In a further particularly preferred configuration, the cover flap is arranged on the battery pack receptacle so as to be pivotable about a pivot axis with respect to the receiving bay. It has been found to be advantageous when the pivot axis extends in particular parallel to a longitudinal direction of the carrying device.

The invention is likewise achieved by a backpack system having an above-described backpack device, wherein the backpack system has a battery pack received or able to be received in the battery pack receptacle.

According to an aspect that is able to be protected independently, a carrying device having a battery pack receptacle for receiving a battery pack is specified, wherein the carrying device also has a connection device for connecting a hand-held electrical device. The carrying device is provided with a configuration interface by means of which energy to be output via the connection device is able to be configured in terms of current and/or voltage. The carrying device may be developed in a corresponding way by the features described with respect to the backpack device.

Further advantages will become apparent from the following description of the figures. Particularly preferred exemplary embodiments of the present invention are illustrated in the figures. The figures, the description and the claims contain numerous features in combination. A person skilled in the art will expediently also consider the features individually and combine them to form useful further combinations.

### BRIEF DESCRIPTION OF THE DRAWINGS

Identical and similar components are denoted by the same reference signs in the figures, in which:

FIG. 1 shows a first preferred exemplary embodiment of a backpack device, and

FIG. 2 shows the exemplary embodiment in FIG. 1 with the cover flap open.

### DETAILED DESCRIPTION

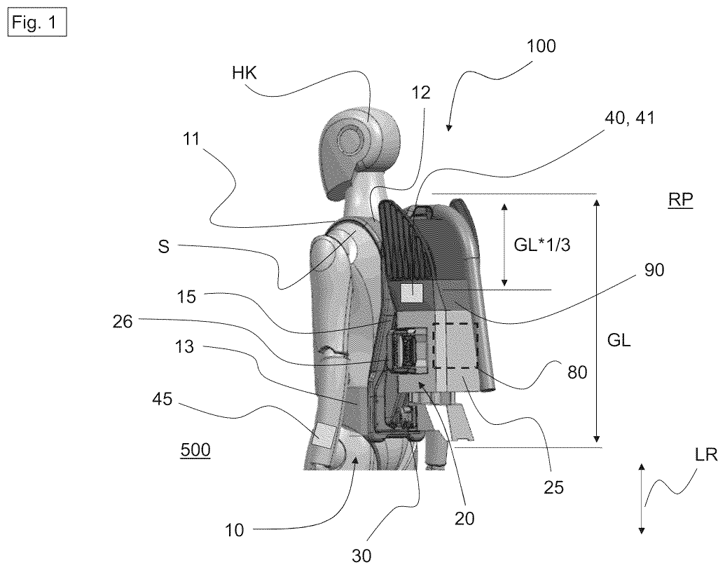

A first preferred exemplary embodiment of a backpack device 100 according to the invention is illustrated in FIG. 1. The backpack device 100 is equipped with a harness unit 10 and a battery pack receptacle 20 for receiving a battery pack 80 (illustrated by dashed lines in FIG. 1 since it is located behind the cover flap 25). The battery pack 80 serves to supply a hand-held electrical device (not illustrated here), for example a concrete vibrator, with energy. The backpack device 100 also has a connection device 30 for connecting the electrical device. The connection device 30 is in the form for example of a 5-pole CEE socket 33.

According to the invention, the backpack device 100 is provided with a configuration interface 40, by means of which energy to be output via the connection device 30 is able to be configured in terms of current and/or voltage. In the exemplary embodiment illustrated here, the configuration interface 40 is in the form of a touchscreen 41, which is arranged on a housing 90 of the backpack device 100. By way of the touchscreen 41, the user HK can set a desired energy configuration, for example 400 V/16 A/50 Hz.

FIG. 1 shows the battery pack receptacle 20 in the so-called back position RP, meaning in particular that a longitudinal direction LR of the backpack device 100 extends parallel (or at least substantially parallel) to a spine of the user HK. In the back position RP, typically both shoulder straps (only the shoulder strap 11 is discernible in FIG. 1) rest on the shoulders S of the user HK. In the back position RP, the waist strap 13 of the harness unit 10 typically passes around a waist of the user HK.

In order for it to be possible to configure energy to be output via the connection device 30 in terms of current and/or voltage even when the battery pack receptacle 20 is located in the shown back position RP, the backpack device 100 is assigned a mobile operator control unit 45 in the form of a smartwatch. The mobile operator control unit 45 communicates via a wireless connection with the configuration interface 40, which for its part has a wireless interface.

The harness unit 10 has a shoulder strap 11, which rests on a shoulder S of the user HK. The harness unit 10 in FIG. 1 has exactly two shoulder straps, wherein the visible shoulder strap 11 is the left shoulder strap. The harness unit 10 also has a base plate 15, which is connected to the shoulder strap 11. The shoulder strap 11 may have a flexurally elastic shoulder bracket 12. The battery pack receptacle 20 is in turn connected to the base plate 15. A waist strap 13 of the harness unit 10 supports load transfer from the battery pack receptacle 20. As can likewise be gathered from FIG. 1, the backpack device 100 has a total length GL in the longitudinal direction LR. The backpack device 100 remains free of the backpack receptacle 20 at least in its top third (GL*1/3). This allows optimal center-of-gravity distribution.

Opening the cover flap 25 by means of the flap closure 26, which has for example a handle, allows easy access to the battery pack 80. The backpack device 100 together with a battery pack 80 that is received or able to be received form a backpack system 500.

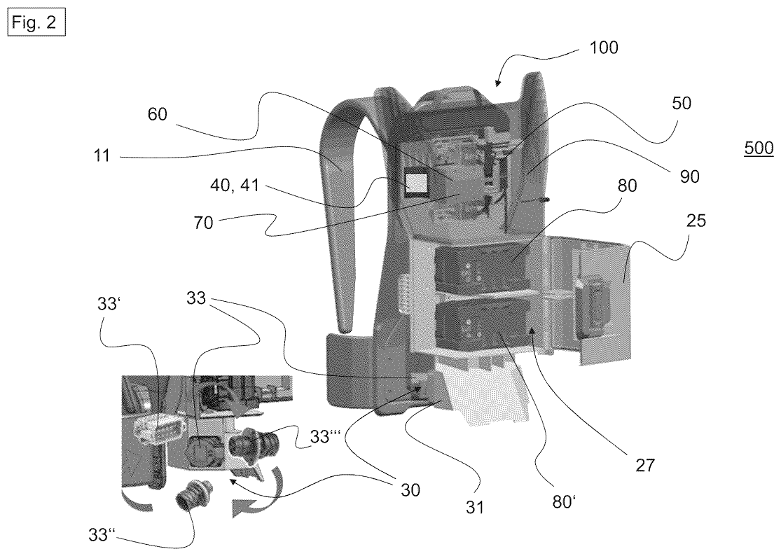

FIG. 2 shows the backpack device 100 from FIG. 1, wherein the cover flap 25 is open. The battery pack receptacle 20 has a receiving bay 27, which can be closed by the cover flap 25. Two battery packs 80, 80′ of the same type are received in the battery pack receptacle 20 in the present case. The backpack device 100 has a switching device 50, by means of which it is possible to switch between a serial connection and a parallel connection of the two battery packs 80, 80′. This takes place via the configuration interface 40 in the form of a touchscreen 41. The housing 90 of the backpack device 100 contains an inverter 60 and a DC-DC converter 70, which can for their part be controlled via the configuration interface 40 in the form of a touchscreen 41.

As already mentioned at the beginning, the backpack device 100 has a connection device 30 for connecting the electrical device. Advantageously, the connection device 30 is modular. The connection device 30 has a universal base 31, on which various sockets 33, 33′, 33″, 33′″ of different types can be fitted. The backpack system 500 may have, as part of a delivery package, a plurality of various sockets 33, 33′, 33″, 33′″ of different types.

### LIST OF REFERENCE SIGNS

10 Harness unit
11 Shoulder strap
12 Shoulder bracket
13 Waist strap
15 Base plate
20 Battery pack receptacle
25 Cover flap
26 Flap closure
27 Receiving bay
30 Connection device
31 Universal base
33 Socket (Type 1)
33′ Socket (Type 2)
33″ Socket (Type 3)
33′″ Socket (Type 4)
40 Configuration interface
41 Touchscreen
45 Mobile operator control unit
50 Switching device
60 Inverter
70 DC-DC converter
80 Battery pack
90 Housing
100 Backpack device
500 Backpack system
GL Total length
HK User
LR Longitudinal direction
S Shoulder

What is claimed is:

1-11. (canceled)

12. A backpack device comprising:
a harness unit;
a battery pack receptacle fastened to the harness unit and for receiving a battery pack;
a connector for connecting a hand-held electrical device; and
a configuration interface, energy to be output via the connector capable of being configured in terms of current and/or voltage via the configuration interface

13. The backpack device as recited in claim 12 wherein the battery pack receptacle is designed to simultaneously receive two battery packs of a same type.

14. The backpack device as recited in claim 12 further comprising a switch enabling switching between a serial connection and a parallel connection of the two battery packs.

15. The backpack device as recited in claim 12 further comprising an inverter and a DC-DC converter.

16. The backpack device as recited in claim 12 wherein the configuration interface is configured in a wireless manner or has a wireless interface.

17. The backpack device as recited in claim 16 further comprising a mobile operator control unit configured to enter into a wireless connection with the configuration interface.

18. The backpack device as recited in claim 12 wherein the connector is modular.

19. The backpack device as recited in claim 12 wherein the connector has a universal base, various sockets of different types fittable on the universal base.

20. The backpack device as recited in claim 12 further comprising a shoulder strap having a flexurally elastic shoulder bracket.

21. The backpack device as recited in claim 12 wherein the battery pack receptacle has a receiving bay and a cover flap for closing the receiving bay.

22. A backpack system comprising:
the backpack device as recited in claim 12; and
a battery pack received or able to be received in the battery pack receptacle.
